(19) United States
(12) Patent Application Publication
(10) Pub. No.: US 2007/0127158 A1
(43) Pub. Date: Jun. 7, 2007

(54) Magnetic recording medium with diamond-like carbon lubricant

(75) Inventor: Nang Tri Tran, Lake Elmo, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/294,868

(22) Filed: Dec. 5, 2005

(51) Int. Cl. G11B 5/78

(52) U.S. Cl. 360/134

(57) ABSTRACT

A magnetic recording medium includes a substrate and a first side. The substrate defines a first surface and a second surface opposite the first surface. The first side extends over the first surface of the substrate and includes a diamond-like carbon (DLC) layer. The DLC layer includes a DLC lubricant.

### GOVERNMENT INTEREST

This invention was made with Government support for a Multi-Terabyte Tape Systems Project under NIST ATP 00-00-4939 awarded by a Government Agency. The Government has certain rights in this invention.

### FIELD OF THE INVENTION

The present invention generally relates to magnetic recording medium, more particularly, to a magnetic recording medium including one or more layers providing lubrication and wear-resistance to the magnetic recording medium and a method of manufacture.

### BACKGROUND

Magnetic recording media are widely used in large volume data storage systems. Magnetic recording media may take the form of magnetic recording tape or hard disks. Magnetic recording media may use thin metallic or partially metallic layers as the recording layers, or may comprise particulate magnetic compositions as the recording layer. Thin, non-particulate layers are typically produced by coating cobalt, nickel, or iron, or an alloy consisting mainly of cobalt, nickel, and iron on a polymeric substrate using an evaporation or other technique. Hard disks are conventionally manufactured by depositing an underlayer, such as a chromium-based underlayer, on an aluminum disk-shaped substrate and depositing a magnetic layer, such as a cobalt, platinum, and chromium-based layer over the underlayer using a sputtering deposition technique. The latter type of magnetic recording media employs particulate material such as ferromagnetic iron oxides, chromium oxides, ferromagnetic alloy powders and the like dispersed in binders and coated on a substrate.

In order to increase durability and to enhance read head movement over the magnetic recording media, additional layers are typically added to the magnetic recording media. In one example, a layer of diamond-like carbon (DLC) is applied over the magnetic layer to provide a wear and corrosion resistance to the magnetic layer and a separate lubricant layer is applied over the DLC layer. The DLC layer is typically coated using thin film deposition techniques such as sputtering, plasma-enhanced chemical vapor deposition (PECVD), whereas the lubricant is typically coated by dip coating.

Organic lubricants have been widely used in the magnetic recording media both in tapes and in hard disks. A thin layer (0.5-2 nm) of lubricant is typically coated on top of a DLC layer using the dipping technique. For example, a lubricant layer may be formed of one of a perfluoropolyether (PFPE), such as Zdol, Ztetraol, Zdiac, AM2001, A₂OH, etc., and is applied over the DLC layer to lubricate the magnetic recording tape for interacting with drive components, such as a read/write head. Lubricants with polar end groups are used to increase adhesion to the adjacent DLC layer. For example, end groups such as hydroxyl (—OH), carboxyl (—COOH) react with the surface and increase bonding of the lubricant to the DLC layer.

Conventional lubricants have a variety of drawbacks. For example, PFPE lubricant layers are very sensitive to environmental factors such as humidity, temperature, and surrounding gases, lack uniform distribution when formed by dipping or evaporation, may reflow or be lost during use, can become localized by migrating to the peripheral portions of the media surface, can easily scratch off of the magnetic recording tape when contacted by the read/write head, may have difficulties forming strong bonds with the DLC layer, and can adversely effect the durability of the magnetic recording media at areas where lubrication has migrated or been removed.

Magnetic recording tapes typically include a backside coating applied to the opposing side of the non-magnetic substrate in order to improve the durability, electrical conductivity, and tracking characteristics of the magnetic recording media. The backside coatings are typically combined with a suitable solvent to create a homogeneous mixture which is then coated onto the substrate. The coated substrate is dried, calendered if desired, and cured. The formulation for the backside coating usually comprises pigments in a binder system.

### SUMMARY

One aspect of the present invention relates to a magnetic recording medium including a substrate and a first side. The substrate defines a first surface and a second surface opposite the first surface. The first side extends over the first surface of the substrate and includes a diamond-like carbon (DLC) layer. The DLC layer includes a DLC lubricant.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 a cross-sectional schematic illustration of one embodiment of a magnetic recording medium.

FIG. 2 is schematic illustration of one embodiment of a portion of the cross-sectional view of FIG. 1.

FIG. 3 is a schematic illustration of one embodiment of a portion of the cross-sectional view of FIG. 1.

FIG. 4 is a schematic illustration of one embodiment of a portion of the cross-sectional view of FIG. 1.

FIG. 5 is a cross-sectional schematic illustration of one embodiment of a magnetic recording medium.

FIG. 6 is a schematic illustration of one embodiment of a deposition system for manufacturing the magnetic recording medium of FIG. 1.

FIG. 7 is a schematic illustration of one embodiment of a deposition system for manufacturing the magnetic recording medium of FIG. 1.

FIG. 8 is a C1s spectra showing CF3, CF2, CF, O-C*—CFn, C-CFn versus binding energy test results for samples A1 and A2.

FIG. 9 is a graph showing coefficient of friction versus operation time test results for a sample A1 and an evaporated X-1P lubricant.

FIG. 10 is a graph showing coefficient of friction versus operation time test results for a sample A2 and an evaporated X-1P lubricant.

FIG. 11 is a graph showing Raman I(D)/I(G) peak height ratio (H) and area ratio (A) versus hardness test results for samples B5-B8.

FIG. 12 is a graph showing G band peak versus hardness test results for samples B5-B8.

FIG. 13 is a graph showing a coefficient of friction test versus an operation time test results for a sample C1.

FIG. 14 is a graph showing a coefficient of friction test versus an operation time test results for a sample D1.

FIG. 15 is a graph showing scratch resistance versus an applied force test results for DLC films prepared by parallel plate plasma enhanced chemical vapor deposition and ion source plasma enhanced chemical vapor deposition.

FIG. 16 is a paragraph showing scratch resistance versus an applied force test results for DLC films prepared by parallel plate plasma enhanced chemical vapor deposition and ion source plasma enhanced chemical vapor deposition.

### DETAILED DESCRIPTION

In the following detailed description, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

Organic liquid lubricants have been used in the manufacture of both magnetic recording tapes and magnetic hard disks. In the past, diamond-like carbon layers have been used for wear resistance, while other diamond-like carbon materials have been known to exhibit relatively low coefficients of friction. However, the coefficient of friction of conventional DLC films are generally inferior to other conventional lubricants used with magnetic recording medium. Accordingly, prior to this invention, embodiments of which are described herein, DLC films have not been used without additional lubricants on magnetic recording media.

In addition, prior to this invention, of which particular embodiments are described herein, the difficulties in encompassing both wear resistance and lubrication in a single layer of DLC film has prevented use of a single DLC film to provide both lubrication and wear resistance. In fact, the composition and deposition techniques have prevented such combination. The DLC layers generally disclosed herein provide a DLC layer exhibiting lubricating properties on par with or superior to conventional lubricants. Moreover, in one embodiment, the properties of the DLC layer are tailored by forming the DLC layer with gas precursors such as fluorine, hydrogen, silicon, and/or metal, by variations in the deposition parameters, and by making changes to the deposition techniques such that the resultant DLC layer acts as a lubricant while simultaneously acting as a wear resistance layer.

The DLC lubricant layer disclosed herein is inorganic and durable and exhibits high hardness, high wear resistance, and high chemical resistance, and provides consistent performance over a relatively long period of operation. As described below, the DLC layer is coated onto the magnetic recording tape using thin film deposition techniques and can be coated on-line with other thin materials in the magnetic recording tape coating processes. In one embodiment, the DLC layer fulfills the following three functions simultaneously: (1) acts as a lubricant on the outermost portion of the DLC layer, (2) provides high hardness and wear resistance in the bulk or intermediate portion of the layer, and (3) provides good adhesion at the interface of the DLC layer to the adjacent magnetic layer. In one embodiment, the DLC layer includes two or more sub-layers in order to provide the three desired functions described above.

Although primarily described below with respect to magnetic recording tapes, it should be understood that DLC layers and or DLC sublayers may be similarly used as lubricants in magnetic disks or other magnetic recording media. In addition to use in conventional tape or disk magnetic recording applications, the DLC lubricant layer is also suitable for use in an ultrahigh density recording medium (e.g., a medium storing data at more than 0.5 Terabit/in²) where the recording is made on the recording medium using a heat source such as a laser beam or an electron beam heating to write data bits to the recording medium. With this type of recording medium, the conventional liquid lubricants are not generally suitable. In particular, when used with heat source recording, conventional liquid lubricants will decompose and/or evaporate. Accordingly, use of a DLC lubricant layer in high heat applications will provide a marked improvement in lubrication especially when used for long periods of time.

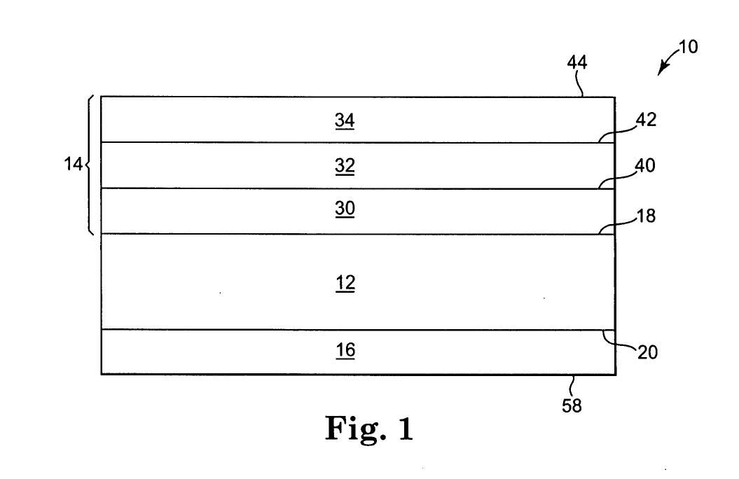

Turning to the figures, FIG. 1 illustrates a schematic, cross-sectional view of a magnetic recording medium, or more particularly, of a magnetic recording tape 10. The magnetic recording tape 10 generally includes a substrate 12, a magnetic side 14, and a backcoat or backside 16. The substrate 12 defines a first or top surface 18 and a back or bottom surface 20 opposite the top surface 18. The magnetic side 14 generally extends over and is bonded to the top surface 18 of the substrate 12. The magnetic side 14 provides the recordable material to the magnetic recording tape 10. In one embodiment, the magnetic side 14 includes a support or underlayer 30, a magnetic layer 32, and a diamond-like carbon (DLC) layer 34. At least a portion of the DLC layer 34 acts as a lubricant for the magnetic recording tape 10 and exhibits a coefficient of friction between about 0.05 and about 0.4 as measured in ambient air. This coefficient of friction range of the at least a portion of the DLC layer 34 is improved over the coefficient of friction of conventional DLC films, which typically range from 0.1 to 1.0 as measured in ambient air.

The backside 16 generally extends over and is bonded to the bottom surface 20 of the substrate 12. The backside 16 generally alters the tribological and electrical properties for the magnetic recording tape 10. In one embodiment, the magnetic recording tape 10 does not include a backside. As used herein, a first component, such as a substrate, layer, side, etc., extending “over” a second component refers to the first component being layered or deposited across a surface on either side of the second component. As such, the term “over” does not refer to an orientation of the magnetic recording tape 10 or a particular side of the second component; nor does “over” suggest direct interaction between the first and second components.

The Substrate

The substrate 12 is any conventional non-magnetic substrate useful as a magnetic recording tape support. Examples of substrate materials useful for the magnetic recording medium 10 include polyesters such as poly(ethylene terephthalate) (PET), poly(ethylene 2,6 naphthalate) (PEN), aromatic poly(amide) (ARAMID), poly(amide) (ARAMID), poly(imide) (PI), poly(benzoxazole( (PBO). In one example, PET or PEN is preferably employed as the substrate 12. In one embodiment, substrate 12 is any other suitable substrate such as AlMg/NiP. In general, the substrate 12 is in elongated tape form or is an elongated sheet configured to subsequently be cut into elongated tape form or is a rigid form cut into a predetermined size such as disks. In one embodiment, where the magnetic recording medium 10 is a disk, the substrate 12 includes or is plated with aluminum.

The Magnetic Side

In one embodiment, the magnetic side 14 is formed in multi-layer construction. In one embodiment, the magnetic side 14 includes the support layer 30, the magnetic layer 32, and the DLC layer 34. The support layer 30 extends over and is bonded to the top surface 18 of the substrate 12. The support layer 30 defines a top surface 40 opposite the top surface 18 of the substrate 12. The magnetic recording layer 32 extends over the substrate 12. More specifically, the magnetic recording layer 32 extends over and is bonded to the top surface 40 of the support layer 30. As such, the magnetic layer 32 defines a recording surface 42 opposite the support layer 30. In other embodiments, the support layer 30 is eliminated and the magnetic layer 32 is bonded directly to the substrate 12. The DLC layer 34 extends over the magnetic layer 32 and defines an outer surface 44 opposite magnetic layer 32. In one embodiment, at least a portion of the DLC layer 34 functions as a lubricant for magnetic layer 32.

In one embodiment, the magnetic layer 10 is formed with a substantially consistent composition. In another embodiment, the magnetic layer 10 may include two or more sublayers. In one example, each sublayer of the magnetic layer 10 is one of a magnetic sublayer and a decoupling sublayer.

In one embodiment where the magnetic recording tape 10 is a thin-film media, the support layer 30 is an underlayer and the magnetic layer 32 formed with evaporation or other thin film deposition technique. The underlayer 30 is deposited on substrate 12 and includes a magnetically soft metal film, such as permalloy, to facilitate perpendicular recording. In one embodiment, the magnetic layer 32 includes cobalt, nickel, or iron or alloys primarily comprising cobalt, nickel, or iron deposited onto the substrate 12 by evaporation. In one embodiment, the underlayer 30 and the magnetic layer 32 include one of CrMn, CoCrMN, and Co-based materials such as CoCrPt, CoNiPt, respectively.

In one embodiment, where the magnetic recording tape 10 is a particulate tape, the support layer 30 is essentially non-magnetic or magnetically soft and, in one embodiment, includes a non-magnetic or soft magnetic powder and a resin binder system. As used herein, the term “soft magnetic powder” refers to a magnetic powder having a coercivity of less than about 300 Oersteds. By forming the support layer 30 to be essentially non-magnetic, the electromagnetic characteristics of the magnetic layer 32 are not substantially adversely affected. However, to the extent that no substantial adverse effect is caused, the support layer 30 may contain a small amount of magnetic powder. In one embodiment, the support layer 30 may also include at least one of a primary pigment material, conductive carbon black, an abrasive or head cleaning agent, a binder resin, a head cleaning agent binder, a service treatment agent, a lubricant, stearic acid, and/or solvents. The materials for the support layer 30 are mixed and the support layer 30 is subsequently coated on upper surface 18 of the substrate 12.

In one embodiment, the magnetic layer 32 includes a dispersion of magnetic pigments, a binder system, a conventional surfactant or wetting agent, and/or one or more solvents. The dispersion of magnetic pigments includes metallic iron and/or alloys of iron and is configured to provide a generally reliable and durable surface for recording and storing data. The materials for the magnetic layer 32 are mixed together and coated onto the upper surface 40 of the support layer 30. In one embodiment, the support layer 30 and the magnetic layer 32 are Cr-based and may include one of CrMn, CoCrMN, and Co-based materials such as CoCrPt, CoNiPt, respectively.

In one embodiment, the DLC layer 34 extends over the magnetic layer 32, and, therefore, over substrate 12, to define the top or outermost surface 44. Otherwise stated, in such an embodiment, no layers or sublayers extend over the DLC layer 34. In other embodiments, additional layers (not shown) may be added over the DLC layer 34. The DLC layer 34 includes materials from a family of amorphous carbon materials that may contain hydrogen and whose properties resemble, but do not duplicate, those of diamond, and are referred to as diamond-like-carbon (DLC) materials. The DLC materials are formed with a significant fraction of sp³-hybridized carbon atoms and can be fully amorphous or can contain diamond crystallites. More particularly, DLC materials containing hydrogen can be described as being formed of a random network of trigonal sp² hybridized carbon atoms and tetrahedral sp³ hybridized carbon atoms. The properties of layers or films of DLC vary with the deposition conditions during formation of the layer or film. In order to achieve desired properties in the DLC layer 34, in one embodiment, the DLC materials are doped with other elements such as fluorine (to lower surface energy and the coefficient of friction), hydrogen (to enhance mobility and reduce friction), silicon (to improve adhesion to the magnetic layer 32), and metal (to lower surface energy and the coefficient of friction).

In one embodiment, the DLC layer 34 includes one or more of a hydrogen content up to about 40 atomic percent, a fluorine content up to about 30 atomic percent, a nitrogen content up to about 30 atomic percent, a silicon content of up to about 40 atomic percent, and a metal content up to about 20 atomic percent of the total chemical components of the DLC layer 34. In a more particular embodiment, the DLC layer 34 includes one or more of a hydrogen content between about 10 atomic percent and about 25 atomic percent, a fluorine content between about 10 atomic percent and about 20 atomic percent, a nitrogen content between about 5 atomic percent and about 20 atomic percent, a silicon content between about 5 atomic percent and about 15 atomic percent, and a metal content between about 2 atomic percent and about 10 atomic percent of the total chemical components of the DLC layer 34. The deposition rate for applying the DLC layer 34 may vary, for example, from between about 0.1 to about 20 nm/second.

The DLC layer 34 is configured to provide at least lubrication to magnetic recording tape 10. In one embodiment, DLC layer 34 is provided over a wear or corrosion resistant layer (not illustrated) extending over the magnetic layer 32 or is directly applied to the recording surface 42 of the magnetic layer 32. In one embodiment, the DLC layer 34 has a thickness in the range of about 0.2 nm to about 2,000 nm depending upon whether any sublayers (further described below) are included in the DLC layer 34. In one example, the DLC layer 34 has a thickness between about 0.5 nm and about 500 nm. In one example, the DLC layer 34 has a thickness of less than about 2 nm. The DLC layer 34 is configured to provide lubrication to the magnetic recording tape 10 to reduce friction on the magnetic layer 32 caused by interaction with a read/write head of an associated tape drive. In one embodiment, the DLC layer 34 is configured to provide lubrication during long periods of use of magnetic recording tape 10. For example, in one embodiment, the DLC layer 34 consistently provides for a coefficient of friction of the magnetic recording tape 10 varying not more than 30%, preferably less than 10%, measured in ambient air with a relative humidity between about 20% and about 60% over 8000 seconds (over two hours) of use.

In one embodiment, the DLC layer 34 has a substantially uniform composition throughout. In one embodiment in which the DLC layer 34 is directly adjacent the magnetic layer 32, the DLC layer 34 is configured to act as a lubricant, act as a wear protectant, and adhere to the magnetic layer 32. Notably, it has been known that the coefficient of friction (COF) of magnetic recording tape 10 varies with the testing conditions (such as head material, contact load, relative running speed of the medium, ambient, interfacial chemistry of the transfer layer between lubricant/head, etc.) and deposition conditions (gas precursor, method, temperature, flow rate, deposition pressure, etc.). In one embodiment, the coefficient of friction of the DLC layer 34 is in the range of about 0.002 to about 0.4 measured in a vacuum below 10⁻⁴ Pa and in the range of about 0.1 to about 1.0 measured in ambient air with a relative humidity between about 20% and about 60%. In one embodiment, the coefficient of friction of the DLC layer 34 is in the range of about 0.05 to about 0.1 in ambient air. In one embodiment, the DLC layer 34 has a coefficient of friction less than 0.4 measured in ambient air at 40% relative humidity, preferably less than 0.15. In one embodiment, the DLC layer 34 has a fracture toughness larger than 1 MPa m^{1/2} and an average wear depth of 10 nm at a contact force of 50 μN. In one embodiment, the DLC layer 34 has a hardness of more than 11 GPa.

In one embodiment, the DLC layer 34 is formed with a plurality of sublayers, where each sublayer is configured to provide particular properties desired for that portion of the DLC layer 34. Each sublayer may be formed with one or more of the doping agents described above. For example, in one embodiment, each DLC sublayer includes one or more of a hydrogen content up to about 40%, a fluorine content up to about 30 atomic percent, a nitrogen content up to about 30 atomic percent, a silicon content of up to about 40 atomic percent, and a metal content up to about 20 atomic percent of the total chemical components of the DLC layer 34. In a more particular embodiment, each DLC sublayer includes one or more of a hydrogen content between about 10 atomic percent and about 25 atomic percent, a fluorine content between about 10 atomic percent and about 20 atomic percent, a nitrogen content between about 5 atomic percent and about 20 atomic percent, a silicon content between about 5 atomic percent and about 15 atomic percent, and a metal content between about 2 atomic percent and about 10 atomic percent of the total chemical components of the DLC layer 34.

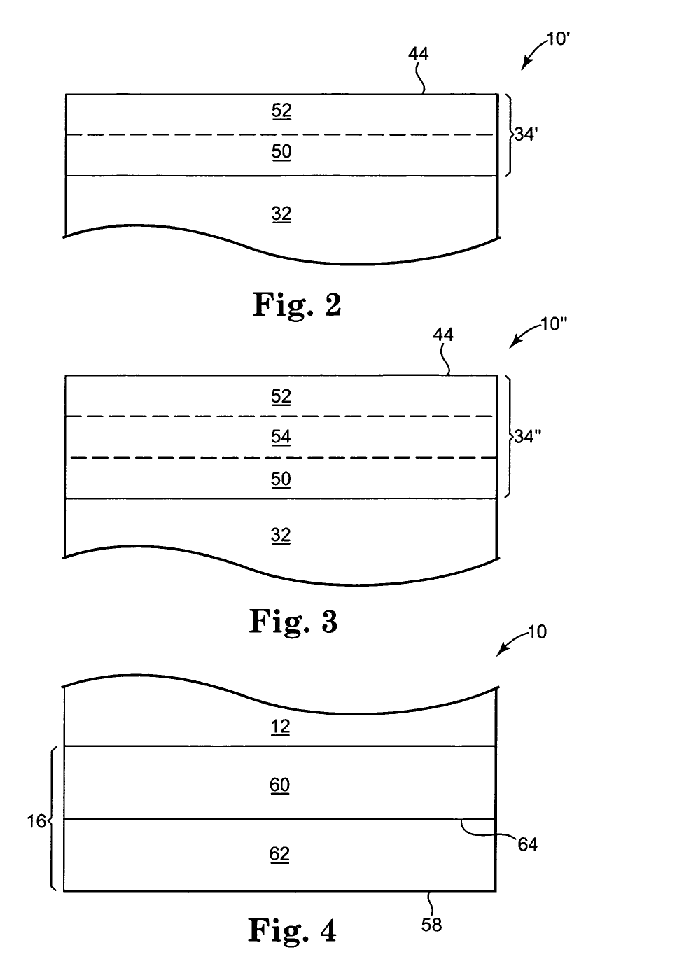

For instance, as illustrated in the embodiment of FIG. 2, the DLC layer 34′ of magnetic recording tape 10′ is formed with a first sublayer 50 and a second sublayer 52. The first sublayer 50 is adjacent the magnetic layer 32 and provides wear resistance to the magnetic recording tape 10. In one embodiment, the first sublayer 50 has a fracture toughness larger than 1 MPa m^{1/2}, an average wear depth of 10 nm at a contact force of 50 μN, and a hardness of more than 11 GPa. In one embodiment, the first sublayer 50 includes silicon, as will be further described below, to enhance adhesion of first sublayer 50 to the magnetic layer 32.

The second sublayer 52 extends over the first sublayer 50 opposite the magnetic layer 32. The second sublayer 52 provides lubrication to the magnetic recording tape 10. In one embodiment, the second sublayer 52 includes a DLC doped with one or more of fluorine, nitrogen, metal and hydrogen to improve the lubricating properties of second sublayer 52. In one embodiment, the second sublayer 52 has a coefficient of friction of less than 0.4 in air at 40% relative humidity at an ambient temperature and under a 40 mN load. In one embodiment, the external surface 44 of the magnetic recording tape 10 is defined by second sublayer 52 opposite the magnetic layer 32.

In one embodiment, as illustrated in FIG. 3, DLC layer 34″ of the magnetic recording tape 10″ includes the first and second sublayers 50 and 52, as described above, but also includes an intermediate or bulk sublayer 54 positioned therebetween. In one embodiment, intermediate sublayer 54 is configured to prevent or decrease the electrostatic discharge of the magnetic recording tape 10. In one embodiment, intermediate sublayer 54 includes a DLC doped with at least nitrogen. Inclusion of two or more sublayers 50, 52, and 54 provides the DLC layer 34″ with more targeted functions such as wear resistance, adhesion, an electrostatic discharge decrease and/or lubrication at each sublayer within the DLC layer 34″. Although primarily referred to as the DLC layer 34 below, it should be understood that the DLC layers 34′ and 34″ could be interchanged with the DLC layer 34.

In one example, the DLC layer 34 is alternatively or additionally formed with a fluorine gradient in which the amount of fluorine in the DLC layer 34 increases from near the magnetic layer 32 to near the outer surface 44. As such, the higher levels of fluorine correspond with the area of the DLC layer 34 that is functioning as the lubricant for the magnetic recording tape 10. In other embodiments, the DLC layer 34 may be formed with a hydrogen or other doping agent gradient that increases or decreases from magnetic layer 32 to outer surface 44. In one example where silicon is used to encourage adhesion between the magnetic layer 32 and the DLC layer 34, a silicon gradient is defined by the DLC layer 34 where the level of silicon in the DLC layer 34 ranges from higher levels near the magnetic layer 32 to lower levels near the outer surface 44. In one embodiment, the DLC layer 34 exhibits both an increasing fluorine gradient and a decreasing silicon gradient measured from the magnetic layer 32 lower levels near the outer surface 44. In one example, the level of silicon near the outer surface 44 is zero. In one embodiment, the DLC layer 34 exhibits an increasing fluorine gradient and a constant hydrogen content.

Whether formed with or without sublayers 50, 52, and/or 54, in one embodiment, the DLC layer 34 is formed to define outer surface 44 with a surface roughness (Rₐ) in the range of about 0.1 nm to about 15 nm, preferably, in the range of about 0.5 nm to about 4 nm. However, the surface roughness depends on the material layer that it is deposed upon and the deposition conditions.

The Backside

Referring to FIG. 1, the backside extends over substrate 12 and defines an outermost surface 58 of the magnetic recording medium 10 opposite the outer surface 44 defined by the magnetic side 14. In one embodiment, the backside 16 includes a soft (i.e., Moh's hardness <5) non-magnetic particle material such as carbon black or silicon dioxide particles. In one embodiment, the backside 16 comprises a combination of two kinds of carbon blacks, including a primary, small carbon black component and a secondary, large texture carbon black component, in combination with appropriate binder resins. The backside 16 is coated onto the bottom surface 20 of the substrate 12 to increase the durability of the magnetic recording tape 10. The backside 16 can also be a DLC layer doped with nitrogen to increase the electrical conductivity of the magnetic recording tape 10.

Although the backside 16 may be formed as a single layer as described above, in one embodiment, as illustrated in FIG. 4, the backside 16 includes a primary layer 60 and a DLC layer 62. The primary layer 60 extends over the substrate 12 and defines a surface 64 opposite the substrate 12. The DLC layer 62 extends over the surface 64 of the primary layer 60 to form the outermost surface 58.

In one embodiment, the primary layer 60 includes a soft (i.e., Moh's hardness <5) non-magnetic particle material such as carbon black or silicon dioxide particles. In one embodiment, the primary layer 60 comprises a combination of two kinds of carbon blacks, including a primary, small carbon black component and a secondary, large texture carbon black component, in combination with appropriate binder resins. The primary layer 60 is coated over the bottom surface 20 of the substrate 12 to increase the durability of the magnetic recording tape 10. The backside 16 can also be a DLC layer doped with nitrogen to increase the electrical conductivity of the magnetic recording tape 10.

In one example, the DLC layer 62 includes one or more of fluorine, nitrogen, metal and silicon. In one embodiment, both layers 16 and 62 are substituted with a single layer of DLC which could provide wear resistance, lubrication, reduced electrostatic charge build-up, and/or reduced outgassing from the substrate 12. In one embodiment, the DLC layer 60 is similar to the DLC layer 34 or one of the DLC sublayers 50, 52, and 54. In one example, the entire backside 16 is similar to the DLC layer 34 or one of the DLC sublayers 50, 52, and 54. In one embodiment, at least one of the layers 60 and 62 is conductive and formed with nitrogen and has a surface roughness suitable for air bleeding. In one embodiment, the DLC layer 62 is supplemental to the DLC layer 34. In one embodiment, the DLC layer 62 is included as an alternative to the DLC layer 34.

In one embodiment, the DLC layer 62 is formed to define an outer surface 58 with a surface roughness (Rₐ) in the range of about 0.1 nm to about 15 nm, preferably, in the range of about 0.5 nm to about 4 nm. The surface roughness depends on the material layer (in this case the primary layer 60 or the substrate 12 material) that the DLC layer 62 is deposited on. In one embodiment, the DLC layer 62 has a thickness in the range of about 0.2 nm to about 2,000 nm depending upon whether any sublayers are included in the DLC layer 62 and the deposition conditions.

Second Magnetic Side

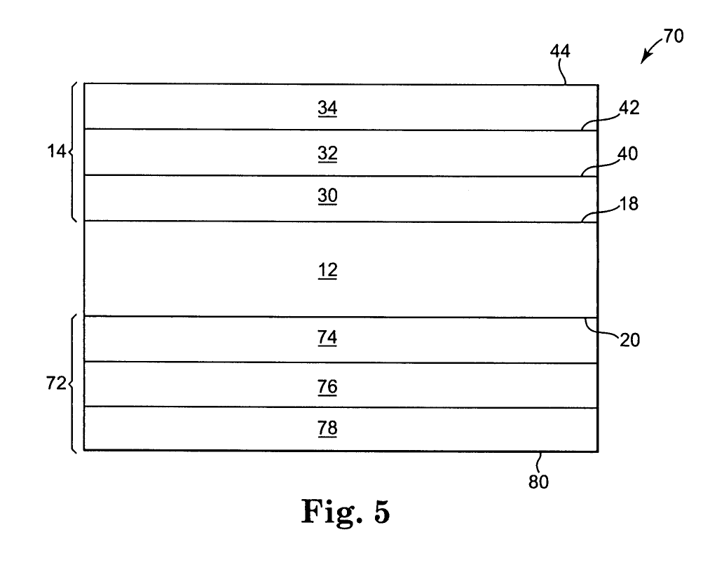

One embodiment of a magnetic recording tape 70 is illustrated in FIG. 5. The magnetic recording tape 70 is similar to the magnetic recording tape 10, however, the backside 16 (FIG. 1) of the magnetic recording tape 10 is replaced with a second magnetic side 72. The second magnetic side 72 extends over the second side 20 of the substrate 12 in a similar manner as the first magnetic side 14 extends over the first side 18 of the substrate. Accordingly, the second magnetic side 72 includes a support or underlayer 74 and a magnetic layer 76 similar to the support or underlayer 30 and the magnetic layer 32, respectively. In one embodiment, the second magnetic side 72 includes a DLC layer 78 extending over the magnetic layer 76. The DLC layer 78 is similar to one of the DLC layers 34, 34′, and 34″ described above. In one embodiment, the DLC layer 78 defines a second outermost surface 80 of the magnetic recording tape 70. In another embodiment, other layers of magnetic recording tape 70 extend over the DLC layer 78.

Manufacturing Process

Although primarily described below as depositing the DLC layer 34, it should be understood that the DLC layers 62 and 78 may be similarly formed as a separate process with a similar system as described for the DLC layer 34. In one embodiment, the DLC layers 62 and 78 are formed by incorporating an additional deposition device(s) similar to the deposition device(s) used to deposit the DLC layer 34 within the systems described below as will be apparent to those of skill in the art.

Ion Source Plasma Enhanced Chemical Vapor Deposition

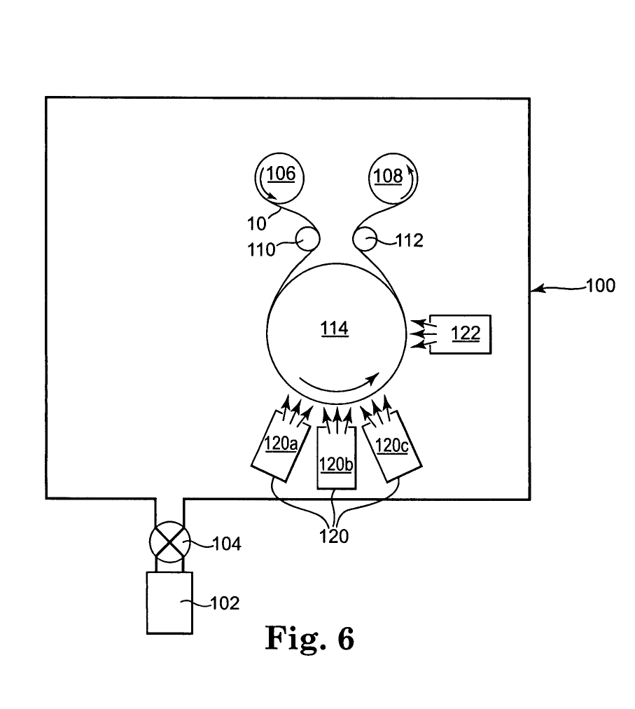

In one embodiment, the DLC layer 34 is deposited onto magnetic recording tape 10 using an on-line ion source PECVD deposition system as illustrated in FIG. 6. A chamber 100 is provided coupled with a vacuum pump 102. The vacuum pump 102 to chamber 100 interaction is regulated by a gate valve 104 positioned therebetween. Vacuum pump 102 creates chamber 100 as a vacuum chamber. A supply roll 106, a take-up roll 108, guide rolls 110 and 112, and a support roll 114 are each mounted within the chamber 100. Supply roll 106 is initially wound with the magnetic recording tape 10 without the DLC layer 34. Take-up roll 108 is initially empty and is configured to receive magnetic recording tape 10 following deposition of the DLC layer 34. As such, rolls 106, 108, 110, 112, and 114 are positioned such that the magnetic recording tape 10 is unwound from supply roll 106, along guide roll 110, along support roll 114, along guide roll 112, and to take-up roll 108. In one embodiment, supply and take-up rolls 106 and 108 are alternately positioned outside of the chamber 100. In one embodiment, the support roll 114 is eliminated and the magnetic recording tape 10 is in a free span mode.

At least one deposition station or, more particularly, ion source 120 is positioned near support roll 114. In one embodiment, where the DLC layer 34 is formed of continuous DLC composition to serve as both the wear protectant and lubricant only one ion source 120 is included. In one embodiment, an ion source 120 is provided for each sublayer 50, 52, and 54 of DLC layer 34. For example, where the DLC layer 34 includes two sublayers 50 and 52, two ion sources 120 are included. Likewise, where the DLC layer 34 includes three sublayers 50, 52, and 54, three ion sources 120 are included.

In one embodiment, each ion source 120 is configured to introduce at least one gas and to ionize the gas forming a plasma and depositing a film onto the target substrate. The precursor gas can be introduced through a body of the ion source 120 or at the periphery of the ion source 120. In one example, the film deposited on the magnetic recording tape at each ion source 120 provides one of the entire DLC layer 34 or one of the sublayers 50, 52, and 54. In one embodiment, the properties of the deposited film are customized based upon the one or more precursor gas, temperature range (between ambient temperature and about 300 C), gas flow rate (between about 10 sccm and about 80 sccm), deposition pressure (between about 0.5 milliTorr and about 100 milliTorr), source-to-substrate distance (between about 2 inches and about 10 inches), substrate moving speed (between about 2 fpm and about 100 fpm), kinetic energy (between about 10 eV and about 2,000 eV), and bias voltages (between about 50 V and about 1,000V).

In one embodiment, the gas used by each ion source 120 includes one of methane, acetylene, benzene, butadiene, cyclohexane, hexafluorobenzene, pentafluorobenzene, or other suitable gas. In one embodiment, to form the DLC layer 34 or one of sublayers 50, 52, and 54 doped with fluorine, a fluorine-containing gas such as CF₄, CHF₃, C₆H₄F₂ or a mixture of a fluorine-containing gas(es) with argon is used. In one example, the fluorine gas is in the form of C₆H₆₋ₘFₘ where m ranges from zero to six. In one embodiment, a carbon contain gas mixed with nitrogen or a nitrogen and argon gas mixture is used to form a nitrogen doped DLC film as the DLC layer 34 or one of sublayers 50, 52, and 54. To form a silicon doped DLC film, a mixture of silane and argon with a carbon-containing gas is used by the respective ion source 120. Accordingly, each ion source 120 may utilize different gases to each form one of the sublayers 50, 52, or 54 having different properties than the other sublayers 50, 52, or 54 as will be apparent to those with skill in the art upon reading this disclosure.

For example, in one embodiment in which DLC layer 34″ as illustrated in FIG. 3 is being formed, a first ion source 120a, a second ion source 120b, and a third ion source 120c are included within the chamber 100. The first ion source 120a uses one of methane, acetylene, benzene, butadiene, cyclohexane, hexafluorobenzene, pentafluorobenzene, a mixture of silane, and argon with a carbon-containing gas or other suitable gas. Accordingly, the first ion source 120a deposits the first sublayer 50 as a wear resistant or a wear resistant with enhanced adhesion DLC sublayer. The second ion source 120b uses a carbon contain gas mixed with nitrogen or a nitrogen and argon gas mixture to form the intermediate layer 54 on the first sublayer 50 doped with nitrogen to decrease electrostatic discharge. The third ion source 120c uses fluorine-containing gas such as CF₄, CHF₃, C₆H₄F₂ or a mixture of a fluorine-containing gas with argon to deposit a fluorine doped sublayer 52 having increased lubricating properties as compared with sublayers 50 and 54. Other gas and sublayer combinations are also contemplated. In one embodiment, the DLC layer 62 is formed simultaneously with one of the sublayers 50, 52, and 54 or is formed with a separate ion source (not shown) similar to one of the ion sources 120.

In one embodiment, a supplemental ion source 122 is included within the chamber 100 downstream from ion source(s) 120 near the support roll 114. The supplemental ion source 122 is configured to provide a treatment of a doping agent, such as fluorine, nitrogen, or silicon after the initial DLC film(s) has been applied to the magnetic recording tape 10. Accordingly, in one embodiment, supplemental ion source 122 uses one of a mixture of silane and/or argon with a fluorine-containing gas, a nitrogen-containing gas, a hydrogen-containing gas, or other suitable gas.

The ion source 122 is for post-treatment of the coated DLC layers 34 and/or 62 and/or sublayers 50, 52, and/or 54. More specifically, surface roughness (Ra) of the DLC layer 34 and/or 62 can be enhanced with nitrogen treatment with the ion source 122 and the surface roughness values can be tailored for the applications of the DLC layers 34 and/or 62 to the front side and/or backside of the substrate 12. The outer surface 62 of the backside DLC layer 62 may be rougher for air bleeding; whereas surface roughness of the front side DLC layer 34 surface 44 may be much smoother. In both cases, the DLC layer 34 or 62 defines protrusions.

The coefficient of friction of the DLC layer 34 and/or 62 can be enhanced by treating the DLC layer 34 and/or 62 with the ion source 122 in fluorine-containing gas, hydrogen-containing gas, and/or nitrogen-containing gas. In one embodiment, the surface roughness of one or more of the DLC layers 34 and/or 62 is in the range of about 0.2 nm to about 15 nm, more particular, in the range of about 0.5 nm to about 4 nm. In one embodiment, the minimum surface roughness of the DLC layer 34 and 62 is determined by surface roughness of the substrate 12. In one embodiment, wherein the DLC layer 34 or 62 is applied by passing magnetic recording tape 10 by ion source(s) 120, supplemental ion source 122 treats the DLC layer 34 or 62 with fluorine to add fluorine to or supplement the fluorine already included in the DLC layer 34 or 62. The surface roughness of individual sublayers 50, 52, and 54, if any, can be similarly enhanced.

After processing with ion sources 120 and/or 122, magnetic recording tape 10 continues along its path and along guide roll 112 to take-up roll 108. Magnetic recording tape 10 with the DLC layer 34 is wound unto take-up roll 108. From the take-up roll, magnetic recording tape 10 can be cut and processed, if necessary, for use in magnetic recording tape products. This process can also be applied to DLC coating on hard disks, using the load-lock vacuum deposition systems known in the art.

Parallel Plate Plasma Enhanced Chemical Vapor Deposition

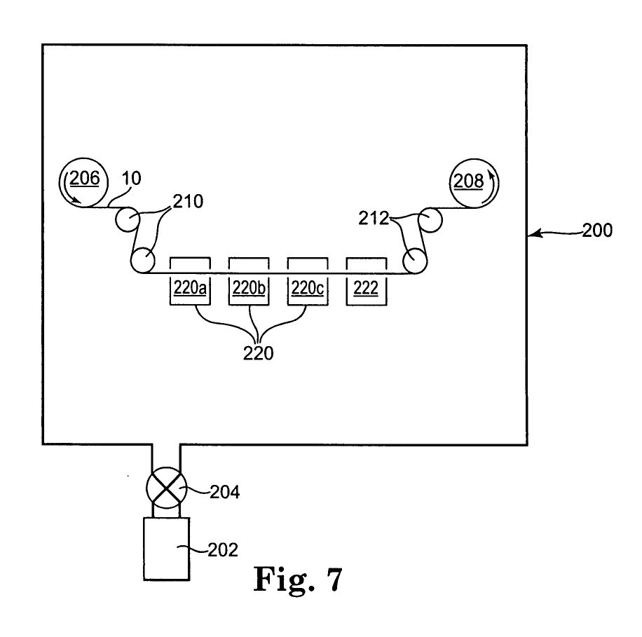

FIG. 7 illustrates one embodiment of a parallel plate plasma enhanced chemical vapor deposition (PECVD) system for forming the DLC layer 34 (illustrated in FIGS. 1-3) on magnetic recording tape 10. A deposition chamber 200 includes an inlet coupled to a vacuum pump 202 and including a gate valve 204 therebetween to regulate interaction between the vacuum pump 202 and the chamber 200. In one embodiment, one or more vacuum pumps 202 and gate valves 204 are in communication with deposition chamber 200. A supply roll 206 and a take-up roll 208 are spaced from each other within the deposition chamber 200. Magnetic recording tape 10 is moved along a tape path between the supply roll 206 and the take-up roll 208 during use. In one embodiment, one or more guide rolls 210 are positioned near supply roll 206 and one or more guide rolls 212 are positioned near take-up roll 208 to assist in guiding the magnetic recording tape 10 along its path.

In one embodiment, one or more deposition stations or, more particularly, internal chambers 220 are positioned between supply roll 206 and take-up roll 208 such that the tape path extends through each internal chamber 220. Each internal chamber 220 is the site of parallel plate PECVD of at least a portion of the DLC layer 34. In one embodiment, each internal chamber 220 deposits one sublayer 50, 52, or 54 onto the magnetic recording tape 10. Accordingly, the number of internal chambers 220 can vary depending upon the number of sublayers 50, 52, and 54, if any, included in the DLC layer 34. In one embodiment, the magnetic recording tape 10 to be deposited with the DLC layer 34 and/or the DLC layer 62 can rest on a mechanical support in each chamber 220.

For example, only one internal chamber 220 is used where DLC layer 34 is formed of a single DLC composition (i.e., where there are no sublayers 50, 52, and 54). Where three sublayers 50, 52, and 54 are included in DLC layer 34, three internal chambers 220 are included within deposition chamber 200. In one embodiment, a first internal chamber 220a (i.e., the internal chamber 220 closest to supply roll 206) is configured to deposit a DLC sublayer 50 (FIG. 3) as a wear protection layer, a second internal chamber 220b is configured to deposit a DLC sublayer 54 (FIG. 3) doped with nitrogen to act as an electrostatic charge reduction layer, and a third internal chamber 220c is configured to deposit a DLC sublayer 52 (FIG. 3) doped with fluorine as a lubricating layer.

In one embodiment in which it is desired to form the DLC layer 34 with a fluorine gradient increasing towards the external surface of the magnetic recording tape 10, plasma in the first internal chamber 220 includes plasma including acetylene, the second internal chamber 220 includes plasma-containing acetylene mixed with a small amount of fluorine-containing gas, and the third internal chamber 220 includes plasma-containing acetylene mixed with a larger amount of fluorine-containing gas. A small opening in each internal chamber 220 allows a portion of the fluorine gas from the second internal chamber 220 to penetrate the first internal chamber 220 and a portion of the fluorine gas from the third internal chamber 220 to penetrate the second internal chamber 220 resulting in a fluorine gradient through the DLC layer 34 with an increasing percentage of fluorine being present in the DLC layer 34 from the interface with the magnetic layer 32 to the external surface 48 of the DLC layer 34. In one embodiment, a gradient of other doping agents is additionally or alternatively deposited by similarly varying the amount of the respective gases in internal chambers 220a, 220b, and 220c as will be apparent to one of skill in the art upon reading this disclosure. In one embodiment, DLC layer 62 is formed simultaneously with one of the sublayers 50, 52, and 54 or is formed with a separate internal chamber (not shown) similar to one of internal chambers 220.

In one embodiment, a supplemental internal chamber 222 is included within deposition chamber 200 between the last internal chamber 220 and the take-up roll 208. Supplemental internal chamber 222 is configured to treat previously deposited layer 34 and/or sublayers 50, 52, or 54 with fluorine or other doping agent. For example, where the DLC layer 34 is deposited at one or more of internal chambers 220, the DLC layer 34 is treated with fluorine through parallel plate PECVD at the supplemental internal chamber 222. Similar approaches for providing a gradient or of other doping agents such as hydrogen can be used in a similar manner as described above for forming a fluorine gradient above. Furthermore, although described above as using acetylene gas (C₂H₂), other gases can also be used such as methane, cyclo-hexane, n-hexane, benzene, and other suitable high carbon-containing gases. In one embodiment, the fluorine-containing gases used are one or more of CF₄, CHF₃, difluorobenze (C₆H₄F₂), a mixture of fluorine-containing gases with argon, or other suitable fluorine-containing gases.

Although described above as using ion beam deposition or parallel plate PECVD, other deposition techniques such as sputtering, filtered cathodic vacuum arc deposition, electron cyclotron resonance (ECR) PEVCD, ion beam assisted deposition, laser assisted deposition and any other suitable deposition technique may be utilized alternatively or in combination with the methods described above. In all the deposition techniques mentioned, temperature plays an important role in controlling contents of hydrogen, fluorine, nitrogen, hardness, surface roughness and electrical conductivity of the DLC layers 34, 62, and/or 78 as well as of any sublayers 50, 52, and/or 54. Further, the deposition systems used to deposit the DLC layer(s) 34, 62 and/or 78 may be operated independently of a deposition system for the magnetic layer or they may be integrated with the magnetic layer deposition system in a single vacuum chamber.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

### TEST EXAMPLES

### Example A

In Example A, fluorine doped DLC films were each deposited on a 2-inch silicon wafer under the following deposition conditions: 200 W power, at ambient temperature, 100 milliTorr, and for a 5 minute deposition time. Sample A1 was deposited with a CF₄/CHF₃ gas ratio of 1/2, and sample A2 was deposited with a CF₄/CHF₃ gas ratio of 1/16. As indicated in Table 1, the larger amount of CF₄ of sample A1 created a DLC layer having a higher fluorine surface concentration as determined using a Physical Electronic Quantum 2000 Scanning XPS with monochromatic AlKα 1486.6 eV for a 600 μm diameter analytical area and a take-off angle of 45 degrees.

TABLE 1
XPS Surface Concentrations (% Atomic Weight)

| Sample | | | | | |
|---|---|---|---|---|---|
| Identification | Carbon | Nitrogen | Oxygen | Fluorine | Chlorine |
| A1 | 44.0 | 0.7 | 1.7 | 53.4 | 0.1 |
| A2 | 46.6 | 0.8 | 2.5 | 50.0 | 0.1 |

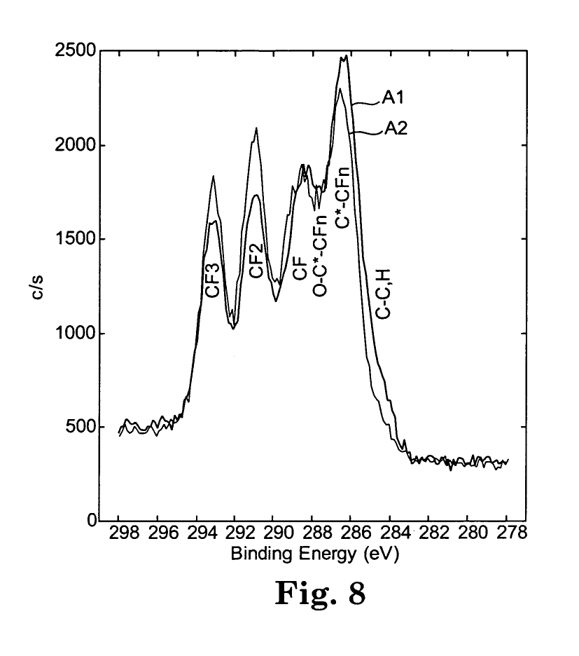

FIG. 8 shows a C 1s spectra of samples A1 and A2 versus binding energy (eV) and indicates the existence of CF₃, CF₂, C*—CFn. Test sample A1 is illustrated to have a higher fluorine content than test sample A2 as well as stronger CF₃, CF₂, C*—CFn peaks in its C 1s spectrum.

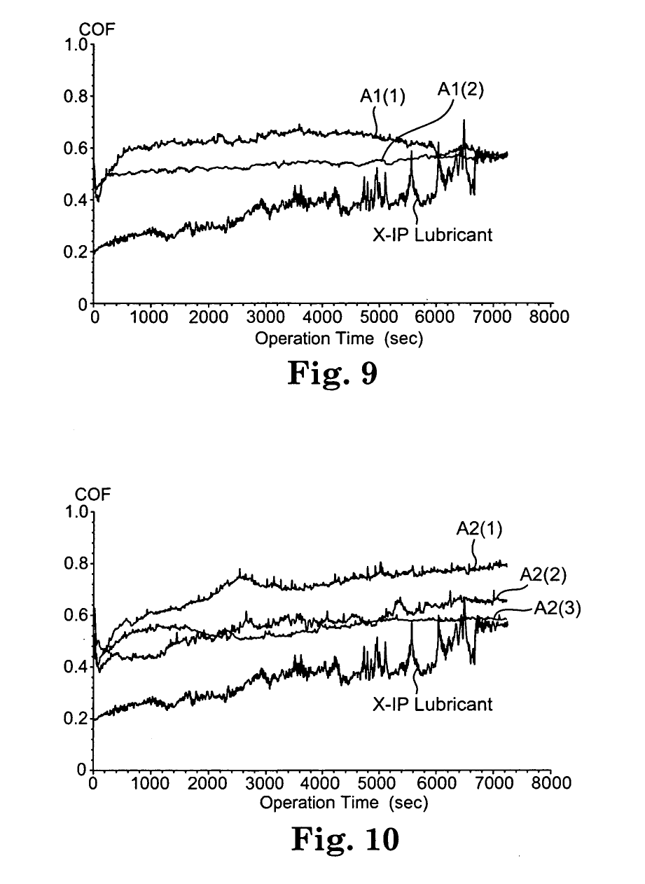

The coefficient of friction of samples A1 and A2 were also measured over 8000 seconds of operation time at a plurality of locations along the DLC layer as indicated in FIGS. 9 and 10 respectively. In particular, two locations A1(1) and A1(2) of sample A1 were tested and three locations A2(1), A2(2), and A2(3) of sample A2 were tested. Viewing FIGS. 9 and 10 in view of Table 1 illustrates that the higher fluorine surface level of sample A1 produced generally lower and more consistent coefficient of friction. Accordingly, higher surface concentrations of fluorine generally appear to provide a more effective and durable lubricant to the magnetic recording tape.

FIGS. 9 and 10 also respectively indicate the coefficient of friction of samples A1 and A2 with respect to the coefficient of friction of a fluorinated hexaphenoxy cyclotriphosphazene X-1P lubricant, which was deposited by evaporation at a boat temperature of 120 C in a vacuum chamber. Although initially higher, the coefficient of friction values for samples A1 and A2 are more stable (i.e., more consistent) throughout the 8000 seconds of magnetic storage tape use. It is expected that with further optimization, the coefficient of friction would be further reduced to the level of the evaporated X-1P lubricant. The coefficient of friction was measured at ambient air and 40% relative humidity using the CETR tribometer unit from the Center for Tribology Research in Campbell, Calif., U.S.A. It is noted that among all the known lubricants deposited using the evaporation technique, such as A₂OH having cyclotriphosphazene as one end group and perfluoropolyether having acrylate at the other end group, evaporated X-1P as a lubricant generally has a lower/comparable coefficient of friction and is more stable over a long period of operation. Notably, X-1P has been widely used in the magnetic recording industry as an additive coated by the magnetic recording medium by dipping. However, this use of evaporated X-1P as a lubricant has not been previously used.

### Example B

In Example B, a variety of DLC samples B1-B8 were each deposited on a 2 inch silicon wafer using ion source PECVD and were tested for hardness and modulus values represented in Table 2. Samples B1-B4 were deposited using a DG-80 plasma source manufactured by Manitou Systems Inc. of Danbury, Conn., U.S.A., and a RF frequency of 80 MHz. Samples B1-B4 were deposited with a mixture of acetylene gas/nitrogen gas at the respective ratios of 1/2, 3/1, 5/1, and 4/1. As shown in Table 2, both the hardness and modulus of the DLC layer increased as the amount of acetylene gas increased.

Samples B5-B8 were deposited using Copra N-160 plasma source manufactured by CCR Technology GmbH of Rheinbreitbach, Germany using an Electron Cyclotron Wave Resonance (ECWR) providing high plasma density. Methane gas was used in the deposition of samples B5 and B6. Acetylene gas was used in the deposition of samples B7 and B8.

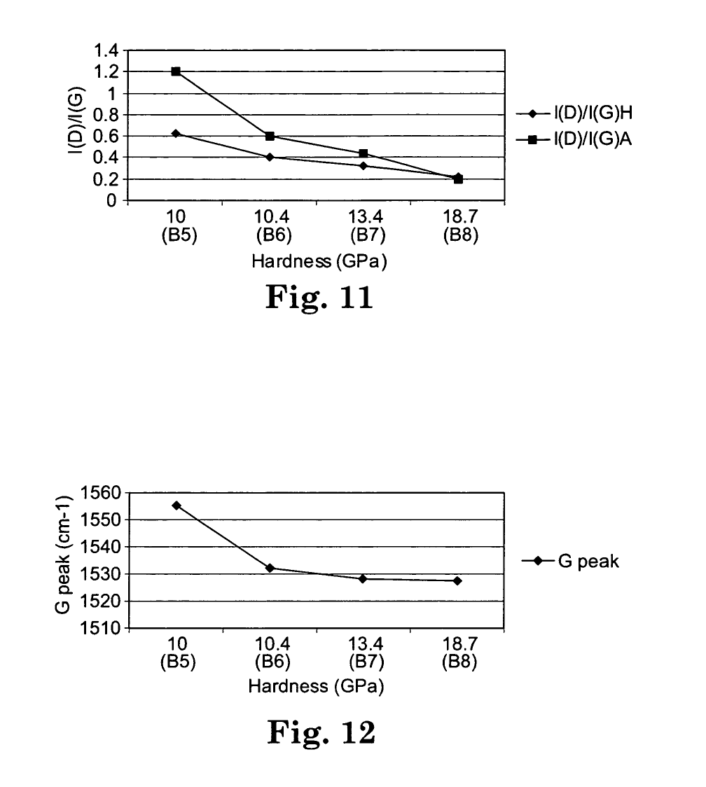

Raman spectroscopy of DLC samples B5-B8 were measured using the Confocal Raman Microscopy CRM 200 from WiTEC of Ulm, Germany. D band value in the proximity of 1332 cm⁻¹ and G band values in the proximity of 1550 cm⁻¹ were observed. A height intensity ratio I(D)/I(G)H and an area intensity ratio I(D)/I(G)A of D band and G band of samples B5-B8 were plotted as a function of hardness as shown in FIG. 11. The position of the G band peak of these samples plotted as a function of the sample hardness is shown in FIG. 12. The results indicate that low I(D)/I(G) ratios from Raman spectroscopy can be used as a routine screening for hardness evaluation without having to measure hardness values directly. The hardness measurement used to obtain the values in FIGS. 11 and 12 were measured using a Hysitron Tribometer™ from Hysitron Inc. of Minneapolis, Minn., U.S.A.

TABLE 2
Hardness and Modulus Data

| Sample | Hardness | Modulus |
|---|---|---|
| Identification | (GPa) | (GPa) |
| B1 | 4.6 | 26.3 |
| B2 | 5.81 | 36.5 |
| B3 | 6.8 | 40.8 |
| B4 | 7.07 | 47.2 |
| B5 | 10 | 72.7 |
| B6 | 10.41 | 83.44 |
| B7 | 13.4 | 105 |
| B8 | 18.7 | 153.3 |

### Example C

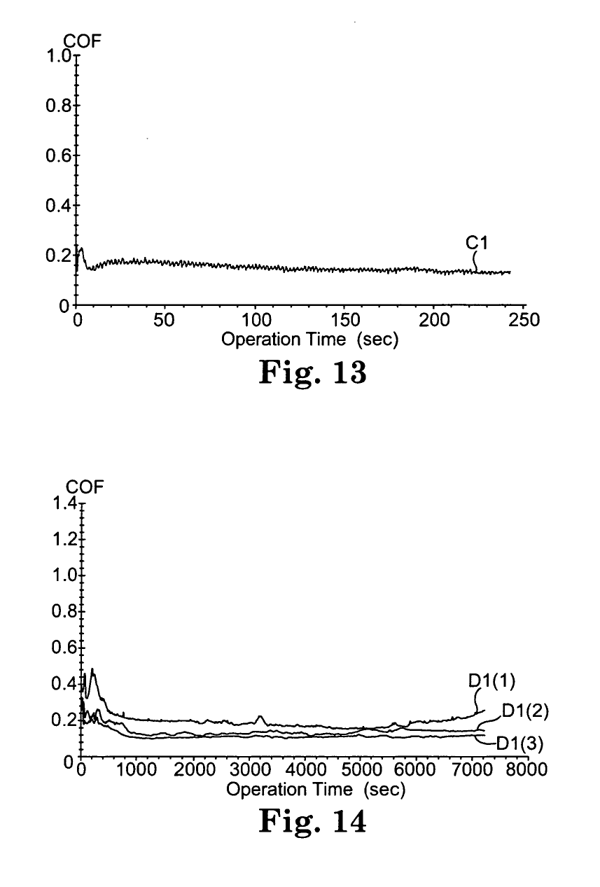

In Example C, a DLC layer was formed on a silicon wafer with ion deposition using acetylene Diamonex ion source G2 available from Morgan Advanced Ceramics, Inc. of Allentown, Pa., U.S.A. Acetylene was used to form a sample denoted as C1 in FIG. 13. The DLC layer was deposited under the following conditions: use of acetylene gas with a flow rate of 15 sccm, use of argon gas with a flow rate of 15 sccm for hollow cathode emission source, use of argon gas with a flow rate of 20 sccm for anode, an anode to ground voltage of 75 V, a magnetic current of 9 Amps, and a source-to-substrate distance of 7 inches. The deposited DLC layer was formed with a thickness of 2,000 A. As illustrated in the chart of FIG. 13, the coefficient of friction of sample C1 is between 0.1 and 0.2 in ambient air with a relative humidity of 40%, which is better than the coefficient of friction for a lubricant mixture of PFPE and X-1P, which is partially fluorinated hexaphenoxy cyclotriphosphazene additive, illustrated in FIGS. 9 and 10. Furthermore, the initial coefficient of friction is stable or even decreasing with operation time as opposed to the conventional lubricant, in which the coefficient of friction increases with operation time.

### Example D

In Example D, a DLC layer was formed on a silicon wafer with ion beam deposition using acetylene Diamonex ion source G2 available from Morgan Advanced Ceramics, Inc. to form a sample denoted as D1 in FIG. 14. The DLC layer was deposited under the following conditions: use of acetylene gas with a flow rate of 15 sccm, use of argon gas with a flow rate of 15 sccm for hollow cathode emission source, use of argon gas with a flow rate of 20 sccm for anode, a deposition pressure of 2.7 MilliTorr, a deposition rate of 6 A per second, and a source-to-substrate distance of 7 inches. The deposited DLC layer was formed with a thickness of 2,000 A. As illustrated in FIG. 14, the coefficient of friction tested at three separate positions D1(1), D1(2), and D1(3) of sample D1 is generally in the range of 0.15 to 0.2 after an initial period of operation in ambient air with a relative humidity of 40%, which is the same as or less than the coefficient of friction seen in conventional lubricants. In addition, as also illustrated with sample C1 in FIG. 13, the coefficient of friction of sample D1 remained stable or actually decreased over a two-hour period of operation. Conventional lubricants typically have an increased coefficient of friction after only 14 minutes of operation. In addition, in a 300 μN nanoindentation test, sample D1 was found to have an average reduced modulus of 77.05 GPa, an average hardness of 15.06 GPa, an average contact depth of 51.51 nm, which all indicate good wear resistance.

A second sample D2 was formed in a similar manner as described above for sample D1. The wear resistance of sample D2 was measured using a Hysitron Tribometer™ available from Hysitron Inc. A wearing force of 100 μN to 500 μN was applied in 100 μN increments with two tests being performed at each increment. The wear areas were fixed at 100 μm². A cube corner diamond indenter tip was raster scanned over the wear area for five passes at 1 Hz each. Wear volume was calculated by measuring the average z-height inside and outside the wear region, calculating the difference between the inside and outside z-heights, and multiplying the difference by the wear area. Table 3 shows the calculated average wear depth and wear volume at each wearing load. The data of Table 3 indicates a high wear resistance of sample D2.

TABLE 3
Average Wear Depth and Wear Volume Test Data
Sample D2

| | Average | |
|---|---|---|
| Wear Load | Wear Depth | Wear Volume |
| (μN) | (nm) | (nm³) |
| 100 | 4.25 | 4.25 × 10⁸ |
| 100 | 4.18 | 4.18 × 10⁸ |
| 200 | 7.01 | 7.01 × 10⁸ |
| 200 | 7.9 | 7.94 × 10⁸ |
| 300 | 16.66 | 1.67 × 10⁹ |
| 300 | 16.32 | 1.63 × 10⁹ |
| 400 | 26.18 | 2.62 × 10⁹ |
| 400 | 23.24 | 2.32 × 10⁹ |
| 500 | 33.85 | 3.39 × 10⁹ |
| 500 | 43.8 | 4.39 × 10⁹ |

### Example E

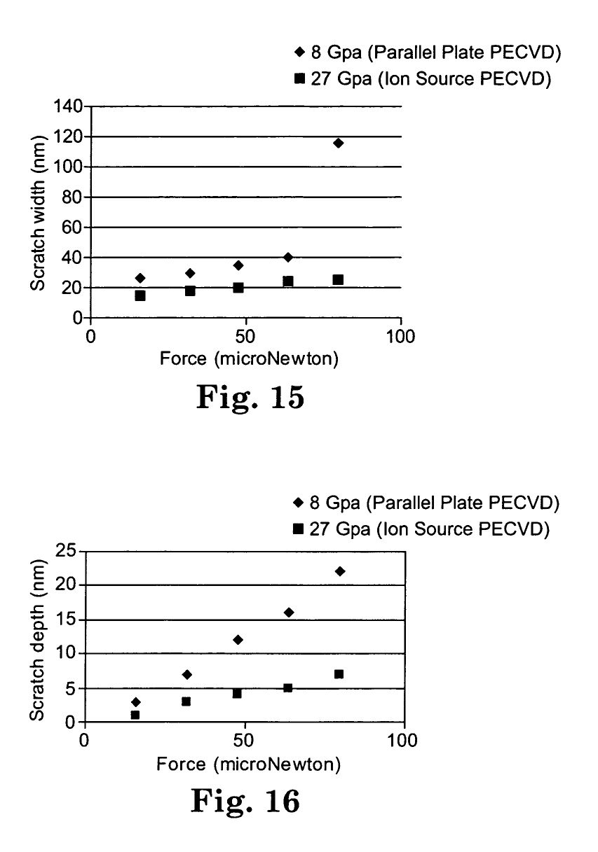

Scratch resistance, both width and depth, at different forces were also studied for DLC films deposited using both parallel plate PECVD and ion source PECVD. The scratch width and depth were measured using Nanoscope IIIa from Digital Instruments of Santa Barbara, Calif., U.S.A. Results of the study are shown in FIGS. 15 and 16, which indicate that the DLC samples having a high hardness, for example, ion source PECVD DLC film with a hardness of 27 GPa, would generally have a higher scratch resistance than DLC samples having relatively low hardness, for example, parallel plate PECVD DLC film having a hardness of 8 GPa.

From these results, the deposition technique is shown to be a main factor affecting the end propertied of the deposited DLC layers. In particular, ion source PECVD produced DLC layers having better tribological properties than DLC layers made with either DC-80 or parallel plate PECVD. The discrepancy in the tribological properties of DLC layers formed with differing deposition techniques is mainly due to a high plasma density in the ion source resulting from a low pressure (about 0.5 to about 3 milliTorr) whereas the pressure in the parallel plate PECVD is relatively high (about 40 to about 100 milliTorr) wherein energy is lost by particle collisions. Consequently, the ion energy distribution of an ion source is generally narrower than its counterpart in parallel plate PECVD.

### Example F

In another example, two strips of a dual-layer particulate DLT tape (¼ inch width×4 inch length) and a 2 inch silicon wafer (for reference) were loaded on a cathode side of a parallel plate plasma enhanced chemical vapor deposition system built by MV Systems Inc. of Boulder, Colo., U.S.A. The system was vacuum pumped to 4.5×10⁻⁷ Torr. with a Varian Turbo V 250 turbo pump prior to deposition. Before deposition, the tape and wafer samples were cleaned with argon plasma at an argon gas flow rate of 10 sccm and an applied voltage of 20 W for 2 minutes.

A DLC layer was deposited onto each of the tape and the wafer under the following deposition conditions: at a cathode-anode distance of 8 inches, at ambient temperature, with an acetylene gas flow rate of 22 sccm, with a nitrogen gas flow rate of 5 sccm, with power of 40 W, at stationary mode, with a frequency of 13.56 MHz, with a deposition rate of 2 A/sec. The DLC layer was applied with a thickness of 36 nm.

The resulting DLC layer adhered well to the DLT tape as determined by the tape peeling test. The DLC layer on the silicon wafer was tested, using the Hysitron Nanoindenter from Hysitron Inc. of Minneapolis, Minn., U.S.A. The hardness of the DLC layer was determined to be 7 GPa and a Raman I(D)/I(G) of 0.4 was obtained. These results were very much the same as those of a DLC layer on a silicon wafer, rather than a DLT tape, at the same deposition conditions.

In another set of experiments, a DLC layer having a thickness of 10 nm was coated on two strips of DLT tapes; and no lines, distortions, or wrinkles were observed on the coated tapes.

What is claimed is:

1. A magnetic recording medium comprising:
a substrate defining a first surface and a second surface opposite the first surface; and
a first side extending over the first surface of the substrate and including a diamond-like carbon (DLC) layer, wherein the DLC layer includes a DLC lubricant.

2. The magnetic recording medium of claim 1, wherein the DLC lubricant defines an outer surface of the DLC layer having a coefficient of friction less than 0.4 measured at ambient air.

3. The magnetic recording medium of claim 1, wherein the DLC layer defines an outermost surface of the magnetic recording medium.

4. The magnetic recording medium of claim 1, wherein the substrate is an elongated flexible substrate, and the magnetic recording medium is a magnetic recording tape.

5. The magnetic recording medium of claim 1, wherein the first side is a magnetic side including a magnetic recording layer, and the magnetic recording medium further comprises a second side extending over the second surface of the substrate.

6. The magnetic recording medium of claim 5, wherein the DLC layer is a first DLC layer, and the second side includes a second DLC layer.

7. The magnetic recording medium of claim 6, wherein the second side is one of a second magnetic side and a backside.

8. The magnetic recording medium of claim 1, wherein the first side is a backside, and the magnetic recording medium further comprises a second side extending over the second surface of the substrate, the second side including a magnetic recording layer.

9. The magnetic recording medium of claim 1, wherein the DLC layer includes at least one of hydrogen, fluorine, nitrogen, silicon, and metal.

10. The magnetic recording medium of claim 1, wherein the DLC layer includes a first DLC sublayer positioned over the substrate and a second DLC sublayer positioned over the first DLC sublayer, and further wherein the first DLC sublayer provides wear resistance to the magnetic recording medium and the second DLC sublayer includes the DLC lubricant.

11. The magnetic recording tape of claim 10, wherein the DLC layer further includes a third DLC sublayer positioned between the first DLC sublayer and the second DLC sublayer, the third DLC sublayer including nitrogen.

12. The magnetic recording medium of claim 1, wherein the DLC layer extends between an innermost surface of the first side and an outermost surface of the first side, and the DLC layer is formed with at least one of a fluorine content gradient increasing as measured from the innermost surface to the outermost surface and a hydrogen gradient increasing as measured from the innermost surface to the outermost surface.

13. A deposition system for depositing a diamond-like carbon (DLC) layer on a magnetic recording medium including a magnetic layer, the coating system comprising:
a supply roll configured to selectively maintain the magnetic recording medium;
a take-up roll spaced from the supply roll and configured to receive the magnetic recording medium from the supply roll, wherein the magnetic recording medium is configured to be advanced from the supply roll to the take-up roll along a medium path;
a deposition station positioned along the medium path and being configured to deposit at least a portion of the DLC layer including a DLC lubricant over the magnetic recording medium; and
a vacuum chamber housing at least a portion of the medium path and the deposition station.

14. The deposition system of claim 13, wherein the deposition station is an ion beam source configured to deposit the at least a portion of the DLC layer using ion source plasma enhanced chemical vapor deposition.

15. The deposition system of claim 13, wherein the deposition station is a parallel plate plasma enhanced chemical vapor deposition chamber.

16. The deposition system of claim 13, wherein the DLC layer includes a plurality of DLC sublayers, and the deposition station is one of a plurality of deposition stations maintained within the vacuum chamber and positioned along the medium path, further wherein each of the plurality of deposition stations is configured to deposit one of the plurality of DLC sublayers over the magnetic recording medium.

17. The deposition system of claim 13, wherein the magnetic recording medium includes an elongated substrate and a magnetic layer extending over the elongated substrate, and the DLC layer is a first DLC layer, further wherein the deposition station is configured to deposit the first DLC layer over the magnetic layer and to deposit a second DLC layer over the substrate opposite the magnetic layer.

18. The deposition system of claim 13, further comprising a supplemental station configured to treat the at least a portion of the DLC layer with a doping agent after the at least a portion of the DLC layer has been deposited by the deposition station.

19. A method of forming an elongated magnetic recording medium, the method comprising:
advancing a magnetic recording medium along a path contained within a vacuum chamber, the magnetic recording medium including a substrate and a magnetic recording layer; and
depositing at least a portion of a diamond-like carbon (DLC) layer including a DLC lubricant over the magnetic recording medium at a deposition station, wherein the deposition station is positioned within the vacuum chamber and along the path, and further wherein the DLC lubricant is deposited to define an outermost surface of the magnetic recording medium.

20. The method of claim 18, wherein the DLC layer includes a first DLC sublayer and a second DLC sublayer, the at least a portion of the DLC layer being the second DLC sublayer and the deposition station being a second deposition station, the method further comprising:
depositing the first DLC sublayer over the magnetic recording medium at a first deposition station positioned within the vacuum chamber along the path, wherein the first DLC sublayer differs in composition from the second DLC sublayer, and the first DLC sublayer is deposited before the second DLC sublayer.
